(19) United States
(12) Patent Application Publication
(10) Pub. No.: US 2006/0139568 A1
(43) Pub. Date: Jun. 29, 2006

(54) Eye mask

(76) Inventor: Hidehiro Kitayama, Tokyo (JP)

Correspondence Address: CISLO & THOMAS, LLP, 233 WILSHIRE BLVD, SUITE 900, SANTA MONICA, CA, 90401-1211, US

(21) Appl. No.: 11/240,001

(22) Filed: Sep. 30, 2005

(30) Foreign Application Priority Data
Dec. 27, 2004 (CN) 200410061505.5

(51) Int. Cl. G02C 7/16

(52) U.S. Cl. 351/46

(57) ABSTRACT

The present invention relates to an eye mask having concave-shaped eye mask portions.

### CROSS-REFERENCE TO RELATED APPLICATIONS

This application claims the benefit of Chinese Patent No. 200410061505.5, which was filed on Dec. 27, 2004 and which is hereby incorporated herein in its entirety by reference.

### BACKGROUND OF THE INVENTION

1. Field of the Invention

The present invention relates to an eye mask, especially relates to an eye mask having concave-shaped eye mask portions so that users can blink in the eye mask when putting on a face and especially relates to an eye mask newly improved by arranging O-rings on grooves provided on rear portions of support members of both sides of the eye mask to secure wearing of the eye mask for improving wearing comfort, and by arranging a strap on the grooves provided on the rear portions of the respective support members so that the eye mask can be hung around user's neck and shoulder when removing the eye mask from user's face for facilitating attachment and detachment of the eye mask.

2. Description of the Related Art

In this kind of conventional eye mask, various structures has been suggested and employed. Among those structures, here, Japanese Utility Model Laid-Open Application Nos. S61-34221 and S61-34222 (not illustrated) can be exemplified as typical structures. Further, in the conventional eye mask, there is no support members, moreover, no engaging means is formed on the support members.

The conventional eye mask is configured as mentioned above, therefore there are the following problems.

At first, in the structure of Japanese Utility Model Laid-Open Application No. S61-34221, eyeballs are directly contacted with an intraocular pressure bag, accordingly the eyeballs are compressed, thereby the user cannot be blinked during use of the mask, thus the eyeballs are tired.

Moreover, in the structure of Japanese Utility Model Laid-Open Application No. S61-34222, cold storage materials are arranged on portions corresponding to eyeballs and this cold storage materials are directly contacted with eyeballs, thereby the user cannot be blinked in the mask, thus the user cannot have a good sleep.

Furthermore, in these conventional structures, when mask is put on a user's face, a behind-the-ear-band must be attached to ears, thus wearing comfort is insufficient and it is difficult to stand long use. Therefore, instead of the behind-the-ear-band, support members are formed and O-rings are arranged on grooves provided on rear portions of the respective support members so as to hold a device of the eye mask securely.

Moreover, when removing the eye mask from the user's face, the mask can be hung around a neck or a shoulder with a strap, thereby storing and usability of the eye mask are improved.

The present invention is made to solve such problems, especially, to provide an eye mask having concave-shaped eye mask portions so that the user can freely blink in the mask when putting on the user's face, thereby wearing comfort and usability in storage are improved.

### SUMMARY OF THE INVENTION

An eye mask set forth in the present invention comprises a first eye mask portion having a concave shape as a whole, a second mask portion having a concave shape as a whole connected to the first mask portion through a connecting portion, plural small holes formed on outer walls of the respective eye mask portions, and circular rim portions formed in the respective eye mask portions.

More specifically, the respective eye mask portions have almost semispherical shapes.

More specifically, the circular rim portions are bent along the user's face.

More specifically, the respective circular rim portion are formed into almost C-shapes in a state connected by the respective outer ends when seeing the eye mask from its top face.

More specifically, the connecting portion is made of an elastic material, and configured so as to be bent freely.

More specifically, in the eye mask comprising support members respectively connected to the first and second mask portions, one or plural groove(s) formed on rear portions of the respective support members and O-ring(s) arranged on one or both of the respective groove(s) are provided.

More specifically, the eye mask comprises one or plural groove(s) formed on rear portions of the respective support members, and a strap provided on one of or both of the respective groove(s).

In an eye mask set forth in the present invention, the respective eye mask portions have concave shapes and sufficient depth, there even when the user blinks, the user's eye does not contact with the eye mask, thus a comfortable wearing condition can be always maintained.

Further, the connecting portion has elasticity and configured so as to be bent freely, therefore, when putting the circular rim portion on the user's face, the respective eye mask portions are biased inwardly by elasticity of the connecting portion, thereby sufficient wearing comfort can be obtained at the respective support members, in addition, by providing the O-rings are engaged with the backs of the user's ears, thereby wearing comfort of the mask to the ear is improved, therefore removal of the eye mask can be securely prevented. As a result, the eye mask can be put on the user's face softly and securely.

Further, the strap is provided at the rear portions of support members through the groove(s), thereby when removing the eye mask from the user's face, the mask can be hung around a shoulder with the strap, therefore attachment and detachment of the eye mask are extremely convenient and storing is facilitated, accordingly the eye mask can be used comfortably.

### BRIEF DESCRIPTION OF THE DRAWINGS

FIGS. 1 to 4 show an eye mask set forth in the present invention, specifically,

FIG. 1 is a front view;

FIG. 2 is a sectional view taken along an A-A line of FIG. 1;

FIG. 3 is a rear view of FIG. 1; and

FIG. 4 is a top view showing a condition of which the eye mask is put on the user's face.

1 denotes an eye mask, 1A a connecting portion, 2 a first mask portion, 3 a second mask portion, 2A, 3A convex portions, 2A″, 3A″ concave portions, D a depth, 4 small holes, 5 outer walls, 6 circular rim portions, and 6A outer end portions.

Furthermore, FIG. 5 is a perspective view of the eye mask. FIG. 6 is an enlarged perspective view of support members. 6A″ denote outer end small hole portions, 11, 12 support members, 11A, 12A rear portions of the support members, 13, 14, 17, 18 grooves, 15 O-rings, and 16 a strap.

### DESCRIPTION OF THE PREFERRED EMBODIMENTS

Preferable embodiments of the eye mask set forth in the present invention will be described in detail together with reference to the attached drawings.

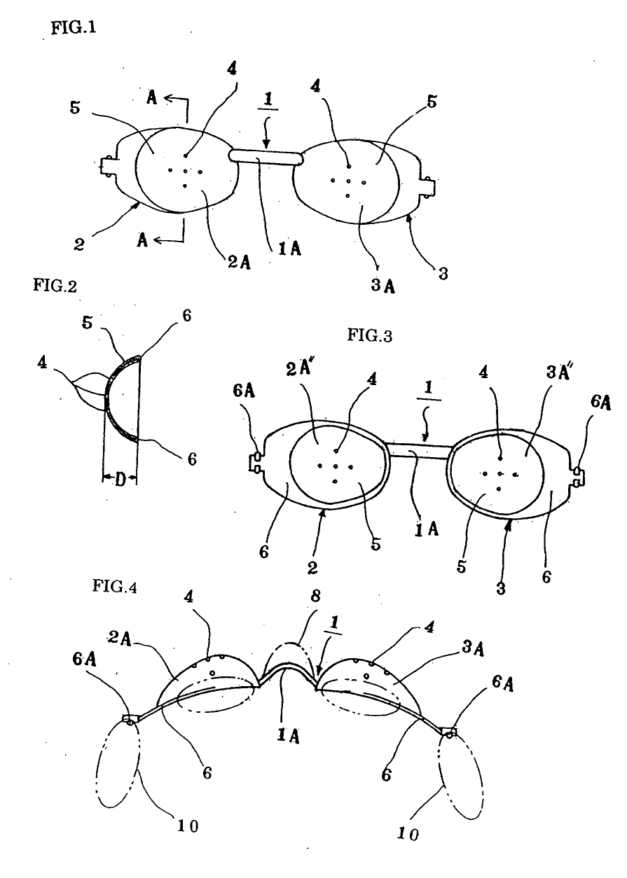

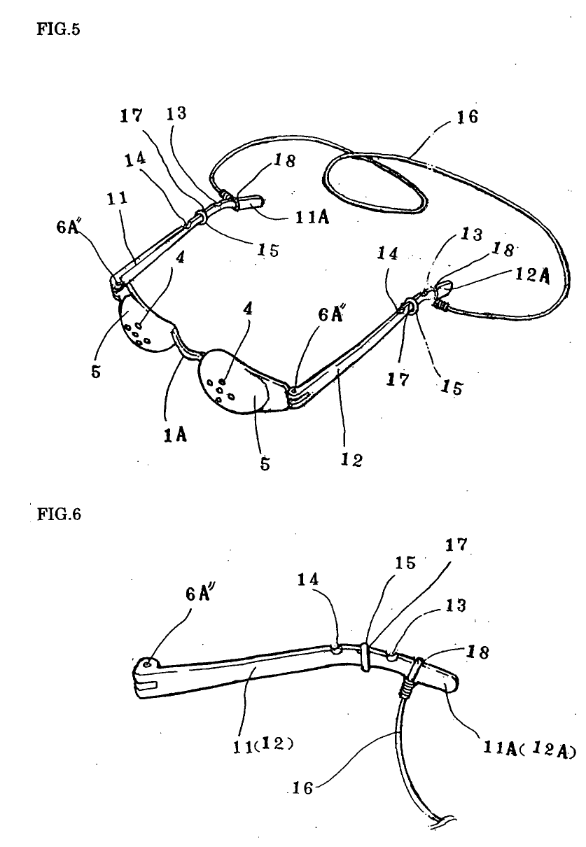

FIGS. 1 to 4 show the eye mask set forth in the present invention. Specifically, FIG. 1 is a front view of the eye mask. FIG. 2 is a sectional view taken along an A-A line of FIG. 1, FIG. 3 is a rear view of FIG. 1, and FIG. 4 is a top view showing a condition of which the eye mask is put on the user's face.

In the drawings, 1 denotes an eye mask having a pair of first and second eye mask portions 2, 3. The respective eye mask portions 2,3 are combined integrally with a connecting portions 1A made of an elastic material having spring characteristics.

The respective eye masks 2, 3 have concave portions 2A″, 3A″ having almost semispherical concave shapes as a whole, and plural small holes 4 are formed on outer walls 5 provided at centers of the respective concave portions 2A″, 3A″ so that the user can see the outside through the small holes 4.

The respective concave portions 2A″, 3A″ have elliptical and semispherical shapes and protruded forward, and as shown in FIG. 2, there is a depth D at the outer walls 5 and the circular rim portions 6 formed at inner peripheries of the respective concave portions 2A″, 3A″.

The respective circular rim portions 6 are formed into almost C-shapes in a state connected by the respective outer ends 6A when seeing the eye mask from its top face as shown in FIG. 4, and in a condition of which the eye mask is put on the user's face, the respective circular rim portions 6 are fit with the user's face and a nose 8 is protruded forward from a connecting portion 1A.

A behind-the-ear-band 10 may be provided at the respective outer ends 6A, if necessary.

Therefore, when putting this eye mask 1 on the user's face as shown in FIG. 4, the nose 8 is protruded from the connecting portion 1A and the respective circular rim portions 6 are inwardly biased by spring characteristics of the connecting portion 1A with bending the connecting portions 1A and the mask can be put on the user's face without using the behind-the-ear-band 10.

In addition, when using this behind-the-ear-band 10 or a behind-the-ear-support members or the like is used, wearing comfort is more improved.

Further, a hard member having no elasticity may be used for the connecting portions 1A.

Moreover, as materials of the respective eye mask portions 2, 3 of this eye mask, any bendable materials such as metal, paper, a nonwoven fabric, foam, plastic, rubber having light shielding property and color (for example, black) can be used. FIGS. 5, 6 are perspective views of the eye mask set forth in the present invention. Plural (or one is possible) groove(s) 13, 14, 17, 18 are provided on rear portions 11A, 12A of the support members 11, 12 and O-ring(s) 15 is/are arranged on the one or both of the respective groove(s) 13, 14, 17, 18. That is, when it is for men, the O-ring(s) 15 is/are provided on the groove(s) 14 of the rear portion(s), and when it is for women, the O-ring(s) is/are located behind ears by arranging the O-ring(s) on the front groove(s) 13, and when the mask is put on a face, the eye mask is securely engaged with ears and slipping off and removing of the mask can be prevented. Further, a strap is located on the grooves of the rear portions, thereby the mask can be hung around a neck or a shoulder with the strap when removing the eye mask from the user's face, attachment and detachment of the mask becomes convenient, and usability of the mask is improved, in addition, a storing manner of the mask is also improved.

The eye mask set forth in the present invention is configured as mentioned above, therefore, the following effects can be obtained.

That is, in the eye mask, only the respective circular rim portions are contacted with the user's face, thereby an extra adhered portion is omitted and cumbersomeness is dissolved thus, comfort in a long time use can be obtained.

Further, the eye mask has sufficient depth so that the user can blink in the eye mask, thereby the user can see an outside well without eyestrain.

Moreover, the connecting portion has elasticity, therefore, the respective eye mask portions are biased toward the user's face by forcing the eye mask on the user's face, thereby a light can be intercepted effectively. The mask can be put on the user's face without feeling uncomfortableness. The O-rings are provide through grooves in the rear portions of the support members, thereby the O-rings are engaged behind ears, and wearing comfort to ears can be improved, thus, removing of the mask or the like can be securely prevented.

Moreover, the total shape of the mask can be made more smaller than a conventional one. Further, by providing the strap, the mask can be hung around a neck and a shoulder with the strap when removing the mask, attachment and detachment of the mask become extremely convenient. The strap can be removed from the support members.

What is claimed is:

1. An eye mask comprising;
a first mask portion having a concave shape as a whole,
a second mask portion having a concave shape as a whole connected to the first mask portion through a connecting portion,
plural small holes formed on outer walls of the respective eye mask portions, and
circular rim portions formed in the respective eye mask portions,
wherein depth are existed between the circular rim portions and the outer walls.

2. The eye mask according to claim 1, wherein the respective eye mask portions have concave portions having almost semispherical concave shapes.

3. The eye mask according to claims 1 to 2, wherein the circular rim portions are bent along a user's face, and formed into almost C-shapes when seeing the eye mask from its top face.

4. The eye mask according to any of claims 1 to 3, wherein the connecting portion is made of an elastic material, and configured so as to be bent freely.

5. The eye mask according to any of claims 1 to 4, comprising support members respectively connected to the first and second mask portions connected by the connecting portion and having plural small holes,
wherein one or plural groove(s) formed on rear portions of the respective support members and an O-ring arranged on one or both of the respective groove(s) are provided.

6. The eye mask according to any of claims 1 to 5, wherein the one or plural groove(s) formed on rear portions of the respective support members, and a strap provided on one of or both of the respective groove(s)
